(19) United States
(12) Patent Application Publication
(10) Pub. No.: US 2006/0102251 A1
(43) Pub. Date: May 18, 2006

(54) Stake manufacturing system

(76) Inventor: Dennis D. Kemmesat, Bismarck, ND (US)

Correspondence Address: Michael S. Neustel;Suite No. 4, 2534 South University Drive, Fargo, ND, 58103, US

(21) Appl. No.: 10/988,385

(22) Filed: Nov. 12, 2004

(51) Int. Cl. B27F 1/00; B27D 1/00; B27G 11/00

(52) U.S. Cl. 144/347; 144/350

(57) ABSTRACT

A stake manufacturing system for effectively recycling waste boards into a stake product. The stake manufacturing system includes providing a plurality of waste boards, creating one or more tooth joints in each of the waste boards, gluing the tooth joints together to form an elongate base board, planing the base board to a desired thickness, cutting the planed board to a desired length and width, and cutting a spiked end into the planed board. The resulting product may thereafter be utilized as a conventional stake for marking boundaries and locations.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to stake manufacturing processes and more specifically it relates to a stake manufacturing system for effectively recycling waste boards into a stake product.

2. Description of the Related Art

Stakes have been manufactured for years and are widely used for marking property lines, building areas and other marking purposes. Conventional stakes are formed from a single piece of lumber that is planed and cut to a desired length and width along with a pointed end for penetrating a ground surface. The main problem with conventional stake manufacturing processes is that they result in a significant non-usable supply of waste boards that are too short to be utilized as stakes or for any other purpose. Hence, there is a need for a stake manufacturing system that recycles waste boards formed during the conventional stake manufacturing process.

While conventional manufacturing systems may be suitable for the particular purpose to which they address, they are not as suitable for effectively recycling waste boards into a stake product. Conventional stake manufacturing processes are wasteful resulting in significant amounts of waste boards that are simply discarded.

In these respects, the stake manufacturing system according to the present invention substantially departs from the conventional concepts and designs of the prior art, and in so doing provides an apparatus primarily developed for the purpose of effectively recycling waste boards into a stake product.

### BRIEF SUMMARY OF THE INVENTION

In view of the foregoing disadvantages inherent in the known types of stake manufacturing processes now present in the prior art, the present invention provides a new stake manufacturing system construction wherein the same can be utilized for effectively recycling waste boards into a stake product.

The general purpose of the present invention, which will be described subsequently in greater detail, is to provide a new stake manufacturing system that has many of the advantages of the stake manufacturing processes mentioned heretofore and many novel features that result in a new stake manufacturing system which is not anticipated, rendered obvious, suggested, or even implied by any of the prior art stake manufacturing processes, either alone or in any combination thereof.

To attain this, the present invention generally comprises providing a plurality of waste boards, creating one or more tooth joints in each of the waste boards, gluing the tooth joints together to form an elongate base board, planing the base board to a desired thickness, cutting the planed board to a desired length and width, and cutting a spiked end into the planed board.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a stake manufacturing system that will overcome the shortcomings of the prior art devices.

A second object is to provide a stake manufacturing system for effectively recycling waste boards into a stake product.

Another object is to provide a stake manufacturing system that forms a stake from waste boards.

An additional object is to provide a stake manufacturing system that is environmentally friendly.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart illustrating the present invention.

FIG. 2 is an upper perspective view of an exemplary waste board.

FIG. 3 is an upper perspective view of the waste board with a tooth joint.

FIG. 4 is a front view of the waste board with a tooth joint.

FIG. 5 is an exploded upper perspective view of a middle board, a first end board and a second end board.

FIG. 6 is an upper perspective view of a base board comprised of the middle board secured to the first end board and the second end board.

FIG. 7 is a side view of the base board.

FIG. 8 is a side view of the base board passing through a planer to create a desired thickness T.

FIG. 9 is a side view of the planed board having a thickness T.

FIG. 10 is an upper perspective view of the planed board cut to a length L and a width W.

FIG. 11 is an upper perspective view of the planed board with a spiked end formed.

### DETAILED DESCRIPTION OF THE INVENTION

A. Overview

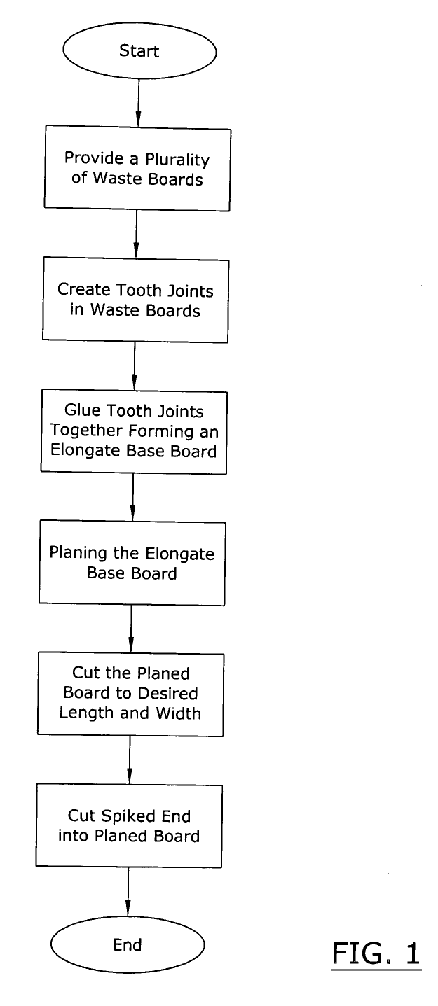

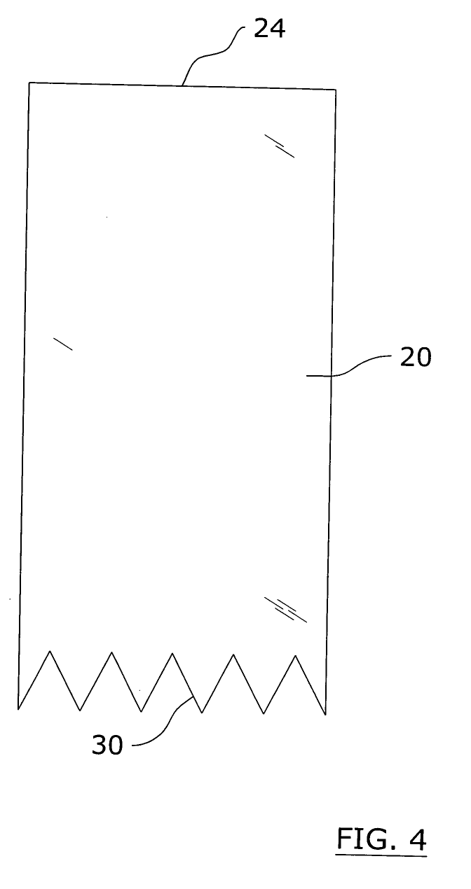

Turning now descriptively to the drawings, in which similar reference characters denote similar elements throughout the several views, FIGS. 1 through 11 illustrate a stake manufacturing system, which comprises providing a plurality of waste boards 20, creating one or more tooth joints 30 in each of the waste boards 20, gluing the tooth joints 30 together to form an elongate base board 40, planing the base board 40 to a desired thickness, cutting the planed board 50 to a desired length and width, and cutting a spiked end 52 into the planed board 50.

B. Providing Waste Boards

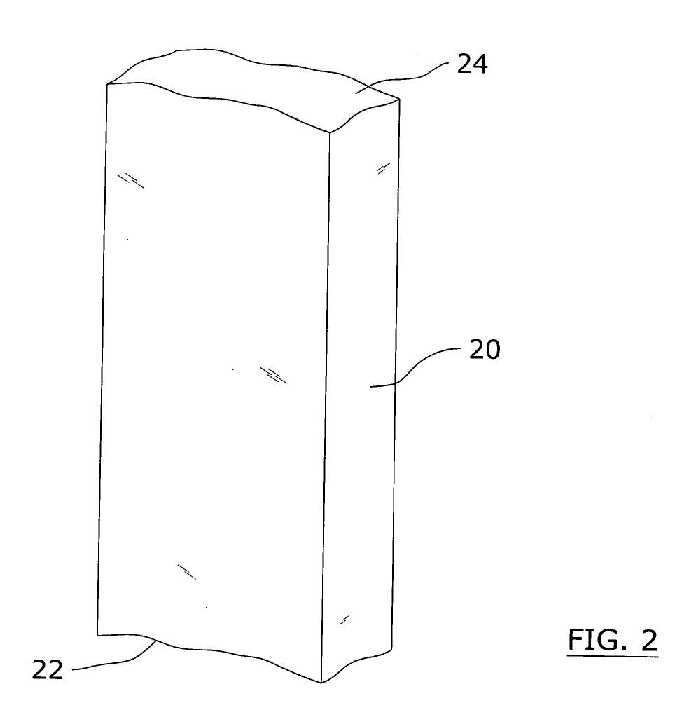

As shown in FIGS. 1 and 2 of the drawings, a plurality of waste boards 20 are provided each having a first end 22 and a second end 24. The waste boards 20 are comprised of a wood material and may be collected from various wood processes that result in shorter waste boards 20 being produced as a by-product. The length of the waste boards 20 is not significant except that the waste boards 20 are each preferably at least 4 inches in length to allow for the formation of adequate tooth joints 30.

C. Creating Tooth Joints

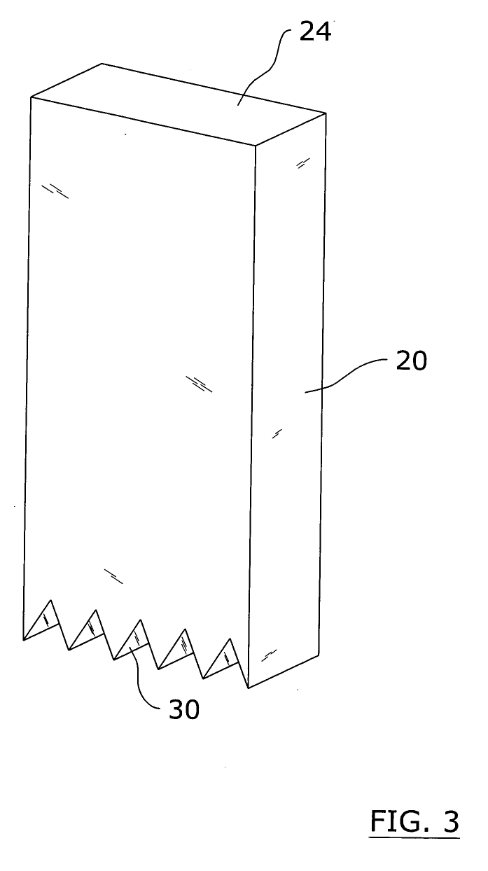

Once the waste boards 20 are provided, one or more tooth joints 30 are formed into each of the waste boards 20 as shown in FIGS. 3 through 5 of the drawings. The tooth joints 30 may be formed using any conventional joint forming tool and process capable of forming a plurality of syncline shaped teeth.

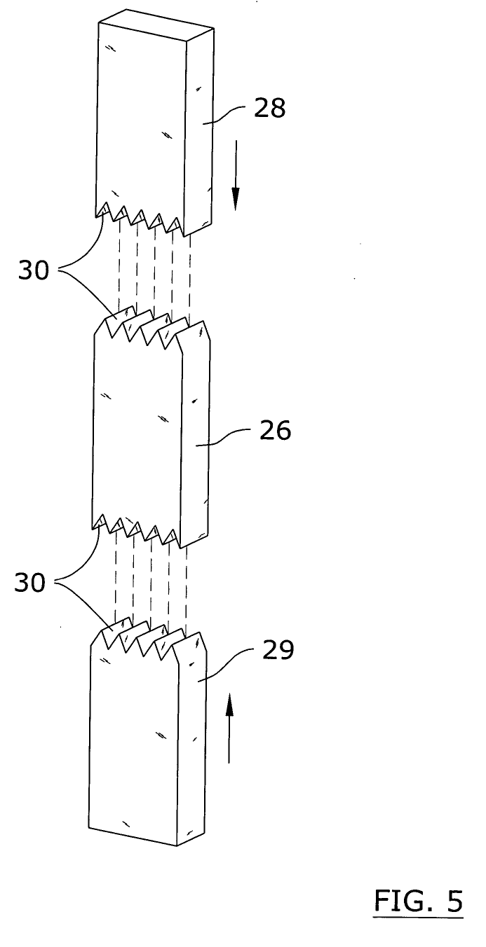

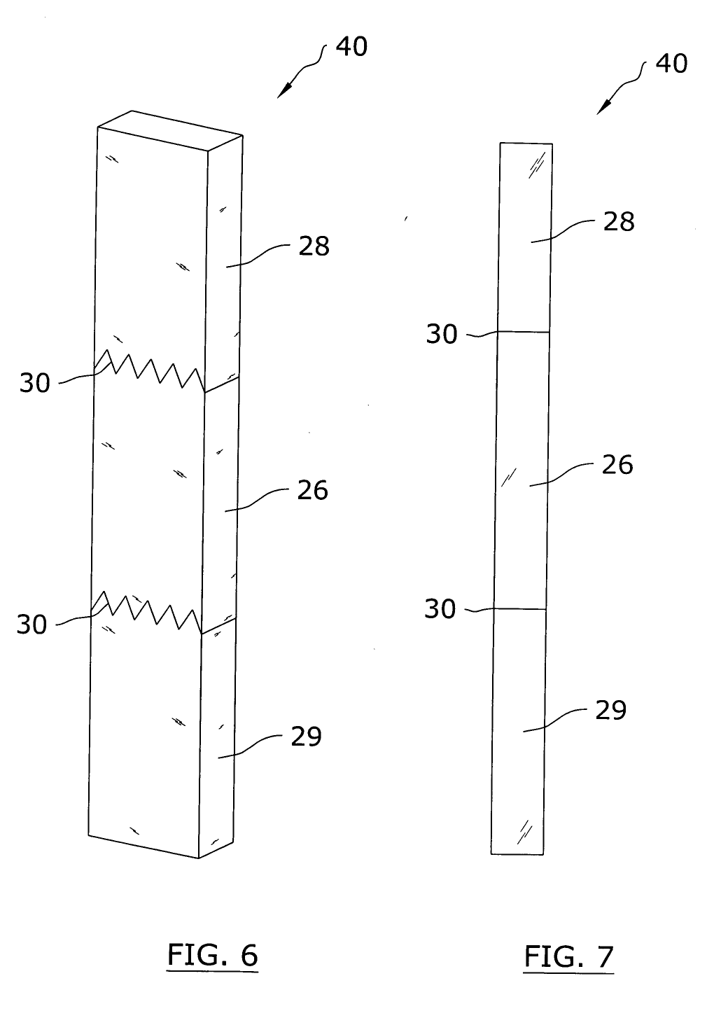

If 3 or more waste boards 20 are being utilized to construct a base board 40, then 1 or more middle boards 26 will be formed having two opposing tooth joints 30 as shown in FIG. 5 of the drawings. There will be a first board 28 and a second board 29 that each have a single tooth joint 30 as further shown in FIG. 5 of the drawings. The tooth joints 30 of each of the waste boards 20 are formed so as to snugly mate with one another in a straight and elongate structure as shown in FIG. 6 of the drawings.

D. Forming Base Board

After the tooth joints 30 are formed, the tooth joints 30 are then glued together to form an elongate base board 40 as shown in FIGS. 1 and 6 of the drawings. The glue may be comprised of any type of wood glue and the securing process may be any conventional wood joint securing process. The glue is allowed to cure thereby forming the elongate base board 40 as shown in FIGS. 6 and 7 of the drawings.

E. Planing Base Board

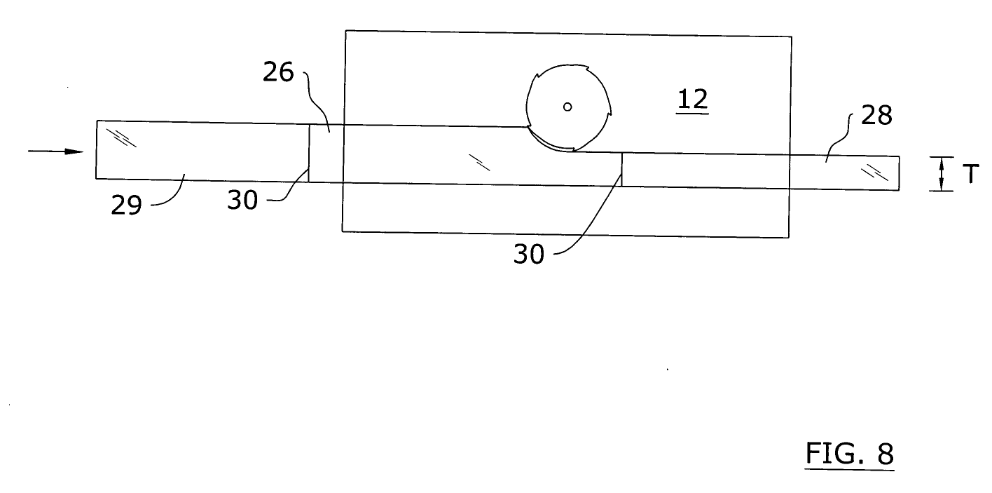

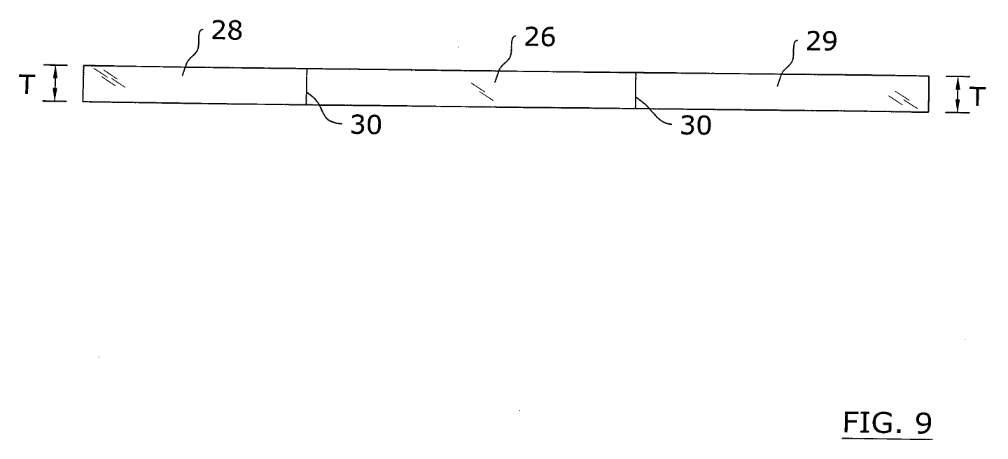

After the elongate base board 40 is formed, the elongate base board 40 is then planed to a desired thickness within a planer 12 forming a planed board 50 as shown in FIGS. 8 and 9 of the drawings. The planed board 50 preferably has a desired thickness T of the elongate base board 40 is preferably approximately between ⅜ of an inch to ¾ of an inch.

F. Cutting Planed Board

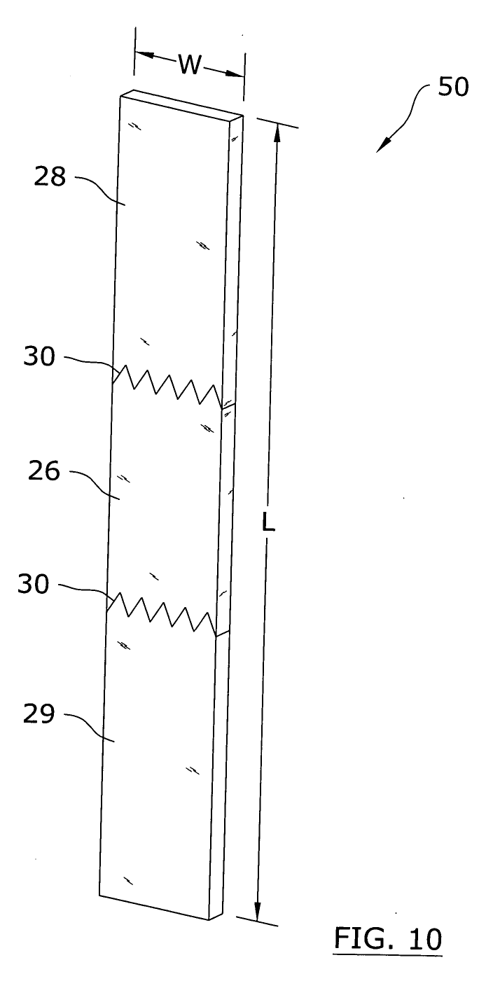

The planed board 50 is then cut to a desired length L as shown in FIG. 10 of the drawings. The desired length L of the planed board 50 is preferably approximately between 12 inches and 48 inches. The planed board 50 may also be cut to a desire width W. The desired width W is preferably approximately 1.5 inches.

G. Forming Spiked End

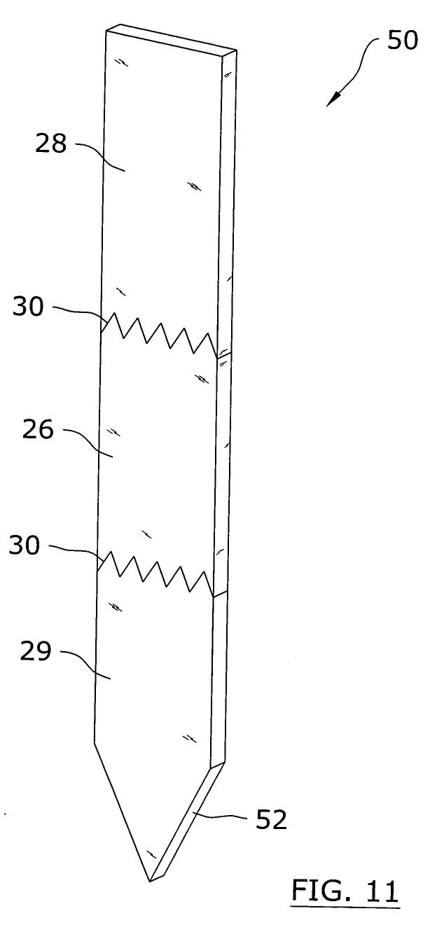

After the planed board 50 has been cut to the desired length L and width W, a spiked end 52 is then formed into an end of the planed board 50 to form a wooden stake as shown in FIGS. 1 and 11 of the drawings. The spiked end 52 preferably has a tapered V-shape as further shown in FIG. 11 of the drawings.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I Claim:

1. A process of manufacturing a wooden stake from waste boards, said process comprising the steps of:
providing a plurality of waste boards, wherein said waste boards are comprised of wood;
creating one or more tooth joints in each of said waste boards;
gluing said tooth joints together to form an elongate base board;
planing said elongate base board to a desired thickness forming a planed board;
cutting said planed board to a desired length; and
forming a spiked end into an end of said planed board to form a wooden stake.

2. The process of manufacturing a wooden stake from waste boards of claim 1, including the step of cutting said planed board to a desired width.

3. The process of manufacturing a wooden stake from waste boards of claim 2, wherein said desired width is approximately 1.5 inches.

4. The process of manufacturing a wooden stake from waste boards of claim 1, wherein said spiked end has a tapered V-shape.

5. The process of manufacturing a wooden stake from waste boards of claim 1, wherein said desired length is approximately between 12 inches and 48 inches.

6. The process of manufacturing a wooden stake from waste boards of claim 1, wherein said desired thickness is approximately between ⅜ of an inch to ¾ of an inch.

7. The process of manufacturing a wooden stake from waste boards of claim 1, wherein said tooth joints are each comprised of a plurality of syncline shaped teeth.

8. The process of manufacturing a wooden stake from waste boards of claim 1, wherein said plurality of waste boards are comprised of a middle board, a first board and a second board, wherein said middle board is secured between said first board and said second board.

9. The process of manufacturing a wooden stake from waste boards of claim 8, wherein said middle board has two opposing tooth joints.

10. The process of manufacturing a wooden stake from waste boards of claim 1, wherein said step of planing said elongate base board is performed through a planer.
